(19) United States
(12) Patent Application Publication
(10) Pub. No.: US 2018/0359293 A1
(43) Pub. Date: Dec. 13, 2018

(54) CONDUCTING PRIVATE COMMUNICATIONS DURING A CONFERENCE SESSION

(71) Applicant: Microsoft Technology Licensing, LLC, Redmond, WA (US)

(72) Inventors: Jason Thomas FAULKNER, Seattle, WA (US); Casey BAKER, Seattle, WA (US)

(21) Appl. No.: 15/616,861

(22) Filed: Jun. 7, 2017

(51) Int. Cl. H04L 29/06

(52) U.S. Cl. CPC H04L 65/403; G06F 3/0483

(57) ABSTRACT

Described herein is a system configured to generate and/or display a side chat conversation within a conference session. The side chat conversation enables communications between some, but not all, of the users participating in a conference session. Consequently, the side chat conversation enables private information to be shared within the context of a conference session. In various examples, a user can provide input that defines an accessibility life span for the side chat conversation and/or an individual communication submitted to the side chat conversation. In this way, access to the side chat conversation and/or the individual communication is limited to a defined period of time and/or to a defined number of accesses. Furthermore, the side chat conversation and/or the individual communication does not become part of a historic record of the conference session over time.

### BACKGROUND

At present, the use of conference (e.g., videoconference) systems in personal, enterprise, and/or commercial settings has increased dramatically so that meetings between people in remote locations can be facilitated. Conference systems allow users, in two or more remote locations, to communicate interactively with each other via live, simultaneous two-way video streams, audio streams, or both. Some conference systems (e.g., CISCO WEBEX provided by CISCO SYSTEMS, Inc. of San Jose, Calif., GOTOMEETING provided by CITRIX SYSTEMS, INC. of Santa Clara, Calif., ZOOM provided by ZOOM VIDEO COMMUNICATIONS of San Jose, Calif., GOOGLE HANGOUTS by ALPHABET INC. of Mountain View, Calif., and SKYPE FOR BUSINESS provided by the MICROSOFT CORPORATION, of Redmond, Wash.) also allow users to exchange files and/or share display screens that present, for example, images, text, video, applications, online locations, social media, and any others.

Consequently, conference systems enable a user to participate in a conference session (e.g., a meeting) via a remote device. In some scenarios, a user participating in a conference session may want to privately communicate with other users participating in the conference session. For example, a meeting may be conducted between a group of people (e.g., a team of ten people), and in the context of that meeting, a user may want to privately communicate with only a subset of the group of people (e.g., one or two other persons). Conventional conference systems do not provide a tool that effectively enables a user participating in a conference session to implement private communications within the conference session, and thus, the user is forced to activate a separate form of communication (e.g., email, text, etc.) to conduct the private communications. As a result, the user is likely to be distracted from the conferencing experience.

### SUMMARY

The disclosed system addresses the problems described above. Specifically, the disclosed system enables a user participating in a conference session to implement private communications with other users participating in the conference session. The communications are “private” in the sense that the system does not allow some of the users participating in the conference session to access the communications. Consequently, the private communications are conducted between a subset (e.g., two or more) of a larger group of users participating in the conference session.

In various examples, the private communications can be accessed (e.g., viewed) via a chat conversation conducted within the conference session. A chat conversation enables users to share messages or comments, reply to messages or comments, share files, share expressions (e.g., emojis), share links to external objects (e.g., a URL), share videos, and/or share other information while viewing live or recorded content of a conference session. A conference session often includes a first chat conversation (e.g., also referred to herein as a “group” chat conversation) in which all the users participating in the conference session have access to the information and activity shared therein. Moreover, as described herein, the conference session can also include a second chat conversation that is a private chat conversation accessible by designated users. The second chat conversation that is private may be referred to as a “side” chat conversation in that some, but not all, of the users participating in the conference session have access to the information and activity shared therein.

The side chat conversation enables a small group of users participating in a conference session to share information and activity in private. The information and activity relates to a context of the conference session, yet likely includes some details or items that a user does not want to share, or sees no need to share, with the whole group participating in the conference session. A communication submitted to a side chat conversation that shares information and/or activity, for example, can include one or more of a message (e.g., typed text), a file (e.g., a document, a slide deck, a spreadsheet, an electronic mail, etc.), an expression that reflects user sentiment or reaction (e.g., an emoji, a “like” icon, a “dislike” icon, etc.), a link to an external object (e.g., a hyperlink to a website, a link to another conference session), a video, or any other information that can be communicated via a chat conversation.

In various examples, activity that occurs in the conference session can be tracked and persisted via a tool that reflects a historic record of the conference session (e.g., an interactive timeline and/or a transcript). In situations where a user does not want the side chat conversation and/or an individual communication shared via the side chat conversation to become part of the historic record of the conference session, the user can choose to associate an accessibility life span with the side chat conversation and/or the individual communication shared via the side conversation. Upon expiration of the accessibility life span, further access to the side chat conversation and/or the individual communication is prohibited by the system (e.g., the side chat conversation and/or the individual communication are deleted from the historic record).

A user that requests the side chat conversation and/or a user that submits the individual communication to the side chat conversation can provide input that defines, as the accessibility life span, a duration of time (e.g., one minute, five minutes, twenty minutes, two days, two months, etc.) for which the side chat conversation and/or the individual communication in the side chat conversation can be accessed. Alternatively, the input provided can define, as the accessibility life span, a number of times the side chat conversation and/or the individual communication can be accessed by individual users in the subset of users designated to access the side chat conversation. For example, the input may specify that access to the side chat conversation and/or the individual communication ends after each user designated to access the side chat conversation views the side chat conversation and/or the individual communication at least one time. Even further, the input provided can define, as the accessibility life span, a total number of times the side chat conversation and/or the individual communication can be accessed by any of the subset of users designated to access the side chat conversation. For example, the input may specify that access to the side chat conversation and/or the individual communication ends after any one user views the side chat conversation and/or the individual communication one time and/or provides a response communication (e.g., an answer is provided to a private question a user does not want to share with the whole group, and once an answer is provided the side chat conversation can no longer be accessed and/or is deleted).

As described herein, the side chat conversation can be displayed in a chat display region of a user interface that also displays the content of the conference session (e.g., live or recorded content). In one example, the chat display region is configured to switch between displaying a first chat conversation, communications of which are accessible and viewable by all the users participating in the conference session, and displaying the side chat conversation (e.g., a second chat conversation), communications of which are private and are only accessible and viewable by a subset of the larger group of users participating in the conference session. The system can switch between displaying the first chat conversation and the second chat conversation based on selection of a tab. In other examples, the chat display region can be configured to concurrently display the first chat conversation and the second chat conversation (e.g., an adjacent view such as a side-by-side view of multiple chat conversations).

In further examples, the system can enable access to a communication submitted to the side chat conversation by adding a representation of the communication to an interactive timeline associated with the conference session. The interactive timeline is a tool that enables a user to view activity associated with a conference session. The interactive timeline can be displayed in association with content of the conference session. The interactive timeline includes representations (e.g., symbols, icons, nodes, thumbnails, etc.) of the activity, and the user is able to interact with individual representations on the interactive timeline to access and/or view information associated with the activity (e.g., so the user can better understand the context of the activity). The interactive timeline can represent a duration or a scheduled duration of the conference session, and thus, each representation on the interactive timeline can also be associated with a timestamp, or a time period, based on when the activity occurs within the conference session with respect to a point of playback of the content of the conference session (e.g., live or recorded content). Accordingly, a representation of a communication submitted to a side chat conversation can be added to the interactive timeline based on a time when the communication is submitted with respect to the playback of the content of the conference session. Upon seeing the representation and performing an interaction (e.g., a hover input, a click or selection, etc.) with the representation, a user in the subset of users designated to access the communication can view the communication (e.g., a message, a shared file, a shared link to an object, etc.).

In various examples, the interactive timeline visually distinguishes (e.g., via color of representations, via size of representations, via pattern or fill of representations, via labels of representations, etc.) between activity that is accessible for all the users participating in the conference session and the activity shared via the side chat conversation that is only accessible to a subset of all the users participating in the conference session. In this way, an individual user participating in the conference session is provided with a personalized interactive timeline based on an extent of the user's involvement in one or more different side chat conversation(s) that include private communications.

In additional or alternative examples, the system can enable access to a communication submitted to the side chat conversation by adding a marker associated with the communication to a transcript of the conference session. The transcript includes text reflecting words spoken during the conference session. A portion or snippet of the text can be associated with a timestamp that indicates when, in the conference session, the text was spoken with respect to a point of playback of the content of the conference session (e.g., live or recorded content). The transcript further includes markers that describe activity that occurs in the conference session. A marker associated with an individual instance of activity can also be associated with a timestamp that indicates when, in the conference session, the activity occurs with respect to a point of playback of the content of the conference session. Based on the timestamps described above, the positions of the markers that describe the activity that occurs in the conference session can be interspersed within the text reflecting the words spoken during the conference session based on times at which the activity occurs. Accordingly, a marker associated with a communication submitted to a side chat conversation can be added to the transcript based on a time when the communication is submitted with respect to the playback of the content of the conference session.

In various examples, the transcript visually distinguishes (e.g., via color of markers, via size of markers, via pattern or fill of markers, etc.) between activity that is accessible for all the users participating in the conference session and the activity shared via the side chat conversation that is only accessible to a subset of all the users participating in the conference session. In this way, an individual user participating in the conference session is provided with a personalized transcript based on an extent of the user's involvement in one or more different side chat conversation(s) that include private communications.

In some implementations, the side chat conversation can comprise an object within the conference session. Accordingly, the side chat conversation and the activity that occurs therein (e.g., communications that are shared) can be associated with its own historic record (e.g., side chat record) that is separately maintained by the system. Thus, the conference session can comprise a first historic record that tracks and reflects activity accessible by all the users participating in the conference session (e.g., activity that occurs in the group chat conversation) and a second historic record that tracks and reflects activity that is only accessible to a subset of all the users participating in the conference session (e.g., activity that occurs in the side chat conversation). As used herein, a subset comprises two or more (e.g., private communications between two or more users). In some instances, a setting can define that the historic record of the side chat conversation is associated with a default accessibility life span (e.g., a default duration of time, a default number of accesses per user, a default number of total accesses, etc.), expiration of which prevents further access and/or deletes the historic record (e.g., deletes the side chat conversation object within the conference session).

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a diagram illustrating an example environment in which a system can generate and display a side chat conversation within a conference session to enable private communications between a subset (e.g., two or more) of users participating in the conference session.

FIG. 2 is a diagram illustrating example components of an example device configured to generate and display a side chat conversation within a conference session to enable private communications between a subset of users participating in the conference session.

FIG. 3A illustrates an example graphical user interface configured to display content of a conference session in a first display region and chat conversation(s) of the conference session in a second display region, the second display region including an option to start a side chat conversation.

FIG. 3B illustrates an example graphical user interface that illustrates an example of how a side chat conversation is displayed in response to a user selecting the option to add or generate the side chat conversation, as illustrated in FIG. 3A.

FIG. 3C illustrates an example graphical user interface that illustrates an example of how a user is notified of a side chat conversation.

FIG. 3D illustrates an example graphical user interface that illustrates another example of how a side chat conversation can be displayed in response to a user selecting the option to add or generate the side chat conversation, as illustrated in FIG. 3A

FIG. 4 illustrates an example graphical user interface in which a user is provided with an option to add an accessibility life span to a side chat conversation and/or an individual communication submitted to the side chat conversation.

FIG. 5A illustrates an example graphical user interface that illustrates another example of how a user can start a side chat conversation.

FIG. 5B illustrates an example graphical user interface that illustrates another example of how a user can start a side chat conversation.

FIG. 6 illustrates an example graphical user interface that illustrates a video that is shared via a side chat conversation.

FIG. 7 illustrates an example graphical user interface configured to display an interactive timeline with representations of communications submitted to a side chat conversation.

FIG. 8 illustrates an example graphical user interface configured to display a transcript that includes markers associated with communications submitted to a side chat conversation.

FIG. 9 is a diagram of an example flowchart that illustrates operations directed to generating a side chat conversation to enable access to private communications.

FIG. 10 is a diagram of an example flowchart that illustrates operations directed to using an accessibility life span to limit access to a chat conversation and/or a communication submitted to a chat conversation.

### DETAILED DESCRIPTION

Examples described herein provide a system configured to generate and/or display a side chat conversation within a conference session. The side chat conversation enables communications between some, but not all, of the users participating in a conference session. Consequently, the side chat conversation described herein enables private information and/or activity to be shared within the context of a conference session. In various examples, a user can provide input that defines an accessibility life span for the side chat conversation and/or an individual communication submitted to the side chat conversation. In this way, access to the side chat conversation and/or the individual communication is limited to a defined period of time and/or to a defined number of times the side chat conversation and/or the individual communication is accessed (e.g., viewed). Furthermore, the side chat conversation and/or the individual communication does not become part of a historic record of the conference session over time.

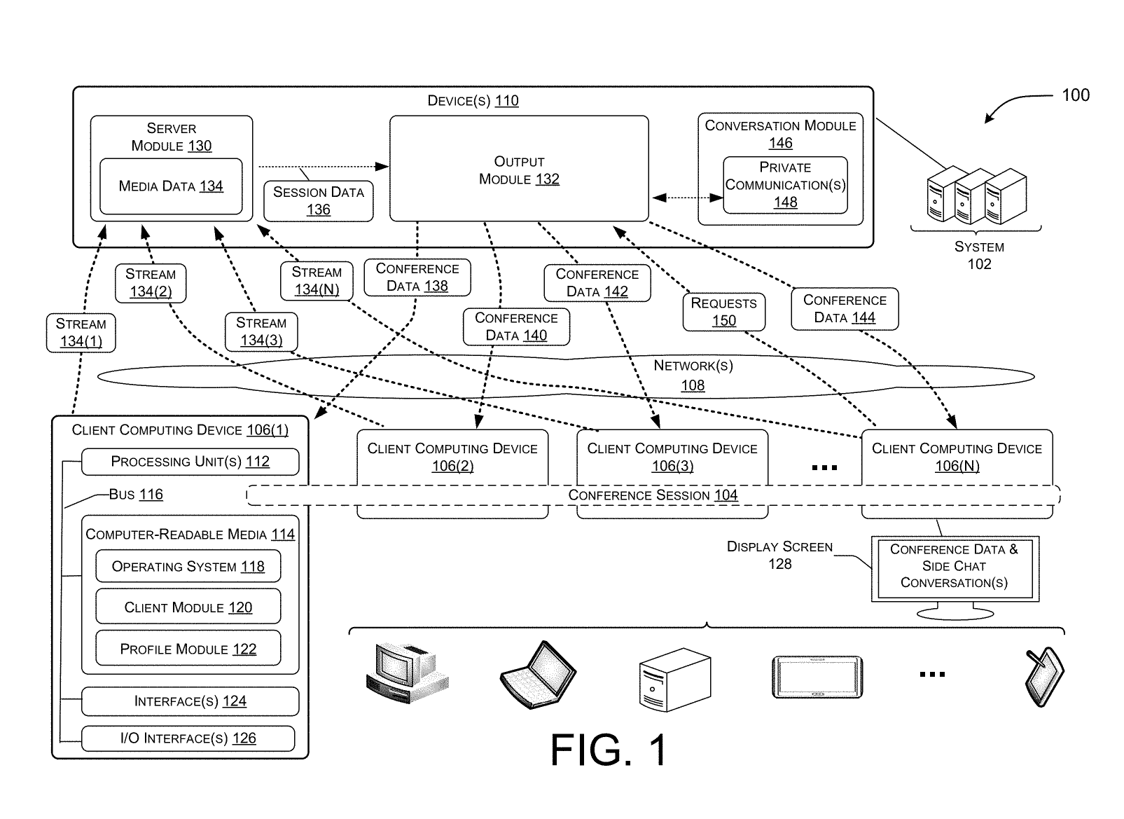

Various examples, implementations, scenarios, and aspects are described below with reference to FIGS. 1 through 10.

FIG. 1 is a diagram illustrating an example environment 100 in which a system 102 can operate to generate and display a side chat conversation within a conference session 104 to enable private communications between a subset (e.g., two or more) of users participating in the conference session. The conference session 104 is being implemented between a number of client computing devices 106(1) through 106(N) (where N is a positive integer number having a value of two or greater). The client computing devices 106(1) through 106(N) enable users to participate in the conference session 104 via a live viewing or a recorded viewing. In this example, the conference session 104 is hosted, over one or more network(s) 108, by the system 102. That is, the system 102 can provide a service that enables users of the client computing devices 106(1) through 106(N) to participate in the conference session 104. Consequently, a “participant” to the conference session 104 can comprise a user and/or a client computing device (e.g., multiple users may be in a conference room participating in a conference session via the use of a single client computing device), each of which can communicate with other participants. As an alternative, the conference session 104 can be hosted by one of the client computing devices 106(1) through 106(N) via utilization of peer-to-peer technologies.

In examples described herein, client computing devices 106(1) through 106(N) participating in the conference session 104 are configured to receive and render for display, on a user interface of a display screen, conference data. The conference data can comprise one instance or a collection of various instances, or streams, of content (e.g., live or recorded content). For example, an individual stream of content can comprise media data associated with a video feed (e.g., audio and visual data that capture the appearance and speech of a user participating in the conference session). Another example of an individual stream of content can comprise media data that includes an avatar of a user participating in the conference session along with audio data that captures the speech of the user. Yet another example of an individual stream of content can comprise media data that includes a file displayed on a display screen and/or audio data that captures the speech of a user. Accordingly, the various streams of content within the conference data enable a remote meeting to be facilitated between a group of people and the sharing of content within the group of people.

The system 102 includes device(s) 110. The device(s) 110 and/or other components of the system 102 can include distributed computing resources that communicate with one another and/or with the client computing devices 106(1) through 106(N) via the one or more network(s) 108. In some examples, the system 102 may be an independent system that is tasked with managing aspects of one or more conference sessions such as conference session 104. As an example, the system 102 may be managed by entities such as SLACK, WEBEX, GOTOMEETING, GOOGLE HANGOUTS, etc.

Network(s) 108 may include, for example, public networks such as the Internet, private networks such as an institutional and/or personal intranet, or some combination of private and public networks. Network(s) 108 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 108 may utilize communications protocols, including packet-based and/or datagram-based protocols such as Internet protocol (“IP”), transmission control protocol (“TCP”), user datagram protocol (“UDP”), or other types of protocols. Moreover, network(s) 108 may also include a number of devices that facilitate network communications and/or form a hardware basis for the networks, such as switches, routers, gateways, access points, firewalls, base stations, repeaters, backbone devices, and the like.

In some examples, network(s) 108 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, and so forth), and other standards.

In various examples, device(s) 110 may include one or more computing devices that operate in a cluster or other grouped configuration to share resources, balance load, increase performance, provide fail-over support or redundancy, or for other purposes. For instance, device(s) 110 may belong to a variety of classes of devices such as traditional server-type devices, desktop computer-type devices, and/or mobile-type devices. Thus, although illustrated as a single type of device—a server-type device—device(s) 110 may include a diverse variety of device types and are not limited to a particular type of device. Device(s) 110 may represent, but are not limited to, server computers, desktop computers, web-server computers, personal computers, mobile computers, laptop computers, tablet computers, or any other sort of computing device.

A client computing device (e.g., one of client computing device(s) 106(1) through 106(N)) may belong to a variety of classes of devices, which may be the same as, or different from, device(s) 110, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorders (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 106(1) through 106(N) of the various classes and device types can represent any type of computing device having one or more processing unit(s) 112 operably connected to computer-readable media 114 such as via a bus 116, which in some instances can include one or more of a system bus, a data bus, an address bus, a PCI bus, a Mini-PCI bus, and any variety of local, peripheral, and/or independent buses.

Executable instructions stored on computer-readable media 114 may include, for example, an operating system 118, a client module 120, a profile module 122, and other modules, programs, or applications that are loadable and executable by processing units(s) 112.

Client computing device(s) 106(1) through 106(N) may also include one or more interface(s) 124 to enable communications between client computing device(s) 106(1) through 106(N) and other networked devices, such as device(s) 110, over network(s) 108. Such network interface(s) 124 may include one or more network interface controllers (NICs) or other types of transceiver devices to send and receive communications and/or data over a network. Moreover, client computing device(s) 106(1) through 106(N) can include input/output (“I/O”) interfaces 126 that enable communications with input/output devices such as user input devices including peripheral input devices (e.g., a game controller, a keyboard, a mouse, a pen, a voice input device such as a microphone, a touch input device, a gestural input device, and the like) and/or output devices including peripheral output devices (e.g., a display, a printer, audio speakers, a haptic output device, and the like). FIG. 1 illustrates that client computing device 106(N) is in some way connected to a display device (e.g., a display screen 128), which can display the conference data and/or a side chat conversation within a conference session user interface.

In the example environment 100 of FIG. 1, client computing devices 106(1) through 106(N) may use their respective client modules 120 to connect with one another and/or other external device(s) in order to participate in the conference session 104. For instance, a first user may utilize a client computing device 106(1) to communicate with a second user of another client computing device 106(2). When executing client modules 120, the users may share data, which may cause the client computing device 106(1) to connect to the system 102 and/or the other client computing devices 106(2) through 106(N) over the network(s) 108.

The client computing device(s) 106(1) through 106(N) may use their respective profile module 122 to generate participant profiles, and provide the participant profiles to other client computing devices and/or to the device(s) 110 of the system 102. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for conference sessions.

As shown in FIG. 1, the device(s) 110 of the system 102 includes a server module 130 and an output module 132. The server module 130 is configured to receive, from individual client computing devices such as client computing devices 106(1) through 106(3), media streams 134(1) through 134(3). As described above, media streams can comprise a video feed (e.g., audio and visual data associated with a user), audio data which is to be output with a presentation of an avatar of a user (e.g., an audio only experience in which video data of the user is not transmitted), file data and/or screen sharing data (e.g., a document, a slide deck, an image, a video displayed on a display screen, etc.), and so forth. Thus, the server module 130 is configured to receive a collection of various media streams 134(1) through 134(3) (the collection being referred to herein as media data 134). In some scenarios, not all the client computing devices that participate in the conference session 104 provide a media stream. For example, a client computing device may only be a consuming, or a “listening”, device such that it only receives content associated with the conference session 104 but does not provide any content to the conference session 104.

The server module 130 is configured to generate session data 136 based on the media data 134. In various examples, the server module 130 can select aspects of the media data 134 that are to be shared with the participating client computing devices 106(1) through 106(N) and/or that are to be configured within a session view. Consequently, the server module 130 is configured to pass the session data 136 to the output module 132 and the output module 132 may communicate conference data to the client computing devices 106(1) through 106(N). As shown, the output module 132 transmits conference data 138 to client computing device 106(1), transmits conference data 140 to client computing device 106(2), transmits conference data 142 to client computing device 106(3), and transmits conference data 144 to client computing device 106(N). The conference data transmitted to the client computing devices can be the same or can be different (e.g., streams and/or the positioning of streams of content within a view of the user interface may vary from one device to the next). The output module 132 can also be configured to record conference sessions (e.g., a version of the conference data) and/or to maintain recordings of the conference sessions. Thus, in some instances, the conference data provided to a client computing device along with a side chat conversation can be recorded data.

The device(s) 110 can also include a conversation module 146 configured to enable private communications 148 to be accessed within a conference session. For instance, client computing device 106(N) can send a request 150 to enable a side chat conversation within the conference session. The side chat conversation can be implemented between a subset of a total number of users participating in the conference session. Accordingly, the request 150 can identify individual ones of the subset of users allowed to access the side chat conversation during a live viewing and/or a recorded viewing of the conference session 104.

In response to receiving the request 150, the conversation module 146 is configured to generate the side chat conversation, receive private communications submitted to the side chat conversation, and/or enable access to the private communications submitted to the side chat conversation for the subset of users. A communication can include information and/or activity that occurs in the context of the conference session such as a message (e.g., typed text), a shared file (e.g., a document, a slide deck, a spreadsheet, an electronic mail, etc.), an expression that reflects user sentiment or reaction (e.g., an emoji, a “like” icon, a “dislike” icon, etc.), a link to an external object (e.g., a hyperlink to a website, a link to another conference session), a video, or any other information and/or activity that can be shared via a chat conversation.

In various examples, to notify users of the side chat conversation and/or a private communication submitted to the side chat conversation, the conversation module 146 configures a chat display region to display the side chat conversation and/or the private communication. Additionally or alternatively, the conversation module 146 can add a representation of the private communication to an interactive timeline and/or add a marker that describes the private communication to a transcript. In some instances, the conversation module 146 is configured to cause a pop up window that includes the private communication to be displayed (e.g., temporarily) as an overlay on top of the live or recorded content of the conference session. When a user accesses a communication submitted to a side chat conversation, the pop up window can be positioned within the user interface so it is graphically associated with another user that is a source of the communication (e.g., the pop up window can be an overlay window positioned on top of a cell that contains the other user, the pop up window can include a visual element that graphically connects it to a cell or another representation of the other user such as a user avatar, etc.).

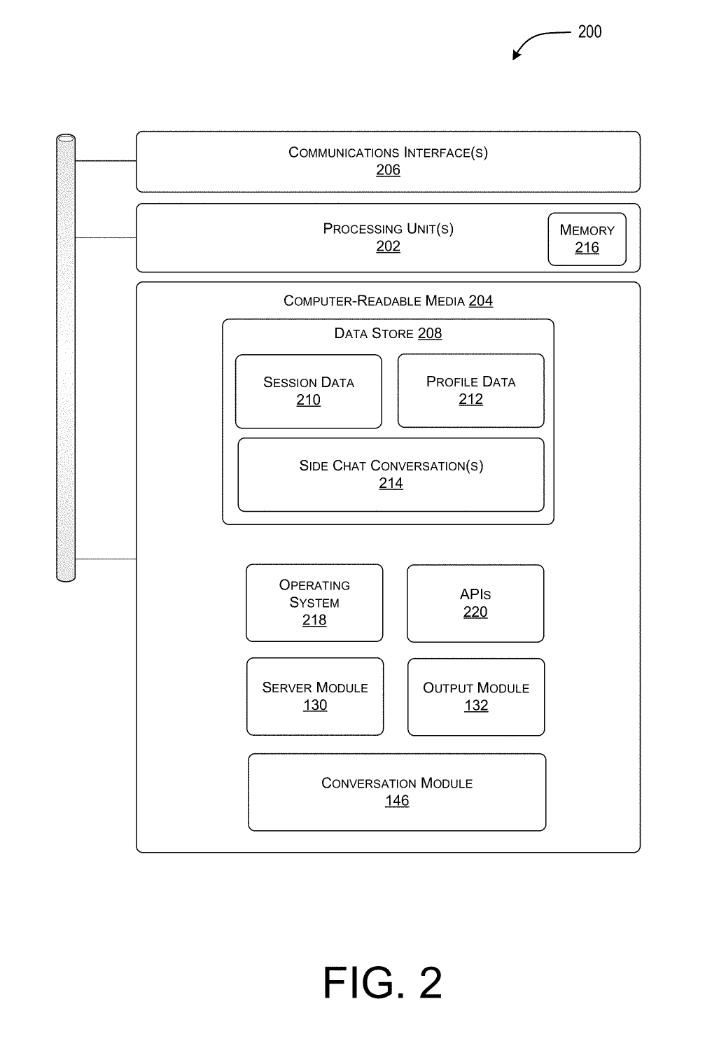

FIG. 2 is a diagram illustrating example components of an example device 200 configured to generate and display a side chat conversation within a conference session 104 to enable private communications between a subset (e.g., two or more) of users participating in the conference session. The device 200 may represent one of device(s) 110, or in other examples a client computing device, where the device 200 includes one or more processing unit(s) 202, computer-readable media 204, and communication interface(s) 206. The components of the device 200 are operatively connected, for example, via a bus, which may include one or more of a system bus, a data bus, an address bus, a PCI bus, a Mini-PCI bus, and any variety of local, peripheral, and/or independent buses.

As utilized herein, processing unit(s), such as the processing unit(s) 202 and/or processing unit(s) 112, may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 204 and/or computer-readable media 114, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 206 may represent, for example, network interface controllers (“NICs”) or other types of transceiver devices to send and receive communications over a network.

In the illustrated example, computer-readable media 204 includes a data store 208. In some examples, data store 208 includes data storage such as a database, data warehouse, or other type of structured or unstructured data storage. In some examples, data store 208 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 208 may store data for the operations of processes, applications, components, and/or modules stored in computer-readable media 204 and/or executed by processing unit(s) 202. For instance, in some examples, data store 208 may store session data 210 (e.g., session data 136), profile data 212 (e.g., associated with a participant profile), and/or other data. The session data 210 can include a total number of participants (e.g., users and/or client computing devices) in a conference session, activity that occurs in the conference session (e.g., notable events), and/or other data related to when and how the conference session is conducted or hosted. The data store 208 can also include side chat conversations 214 (e.g., objects) generated within a conference session to enable private communications to be accessed.

Alternately, some or all of the above-referenced data can be stored on separate memories 216 on board one or more processing unit(s) 202 such as a memory on board a CPU-type processor, a GPU-type processor, an FPGA-type accelerator, a DSP-type accelerator, and/or another accelerator. In this example, the computer-readable media 204 also includes operating system 218 and application programming interface(s) 220 configured to expose the functionality and the data of the device 200 to other devices. Additionally, the computer-readable media 204 can include one or more modules such as the server module 130, the output module 132, and the conversation module 146, although the number of illustrated modules is just an example, and the number may vary higher or lower. That is, functionality described herein in association with the illustrated modules may be performed by a fewer number of modules or a larger number of modules on one device or spread across multiple devices.

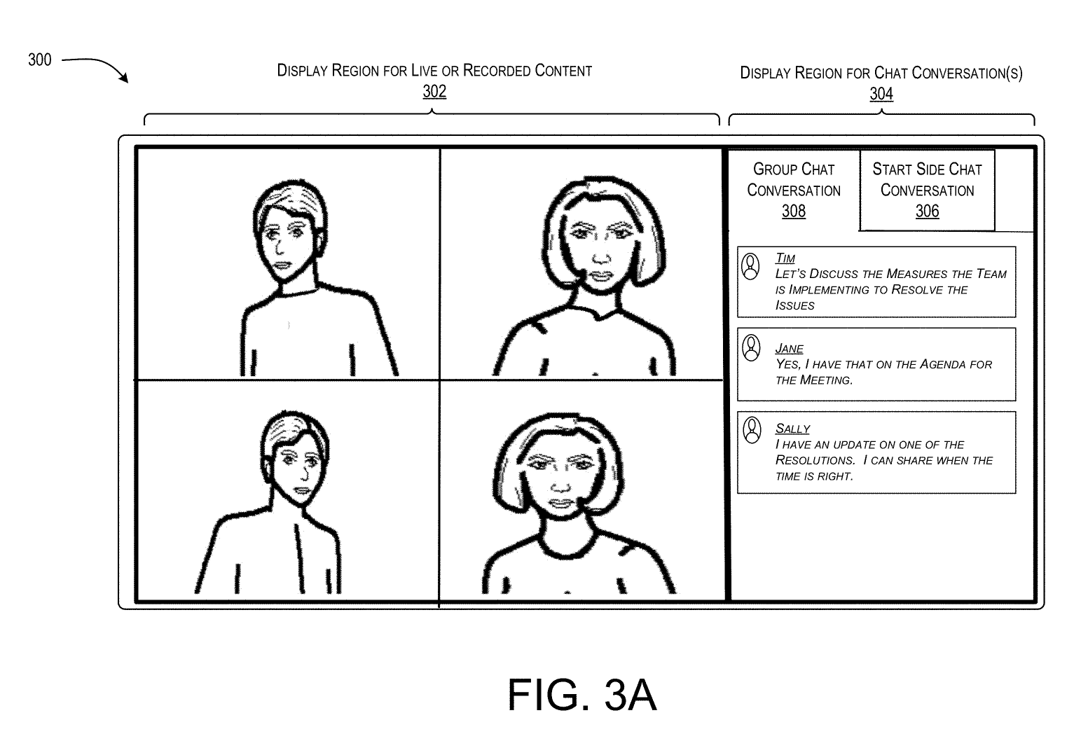

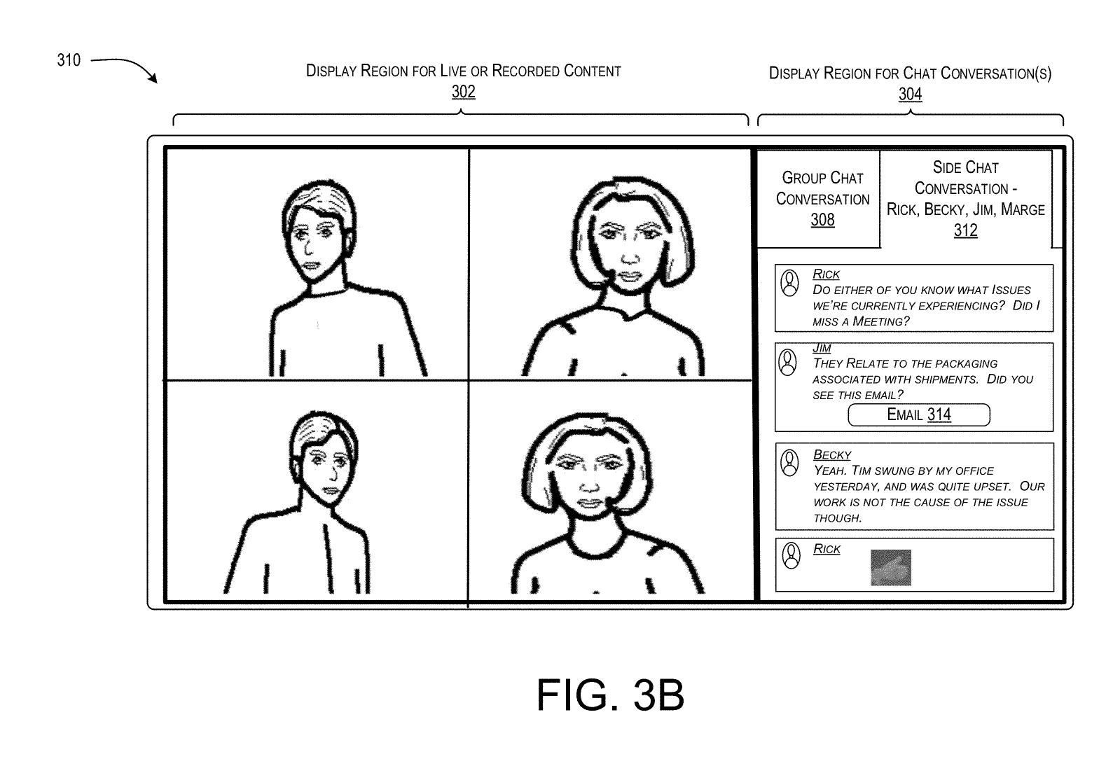

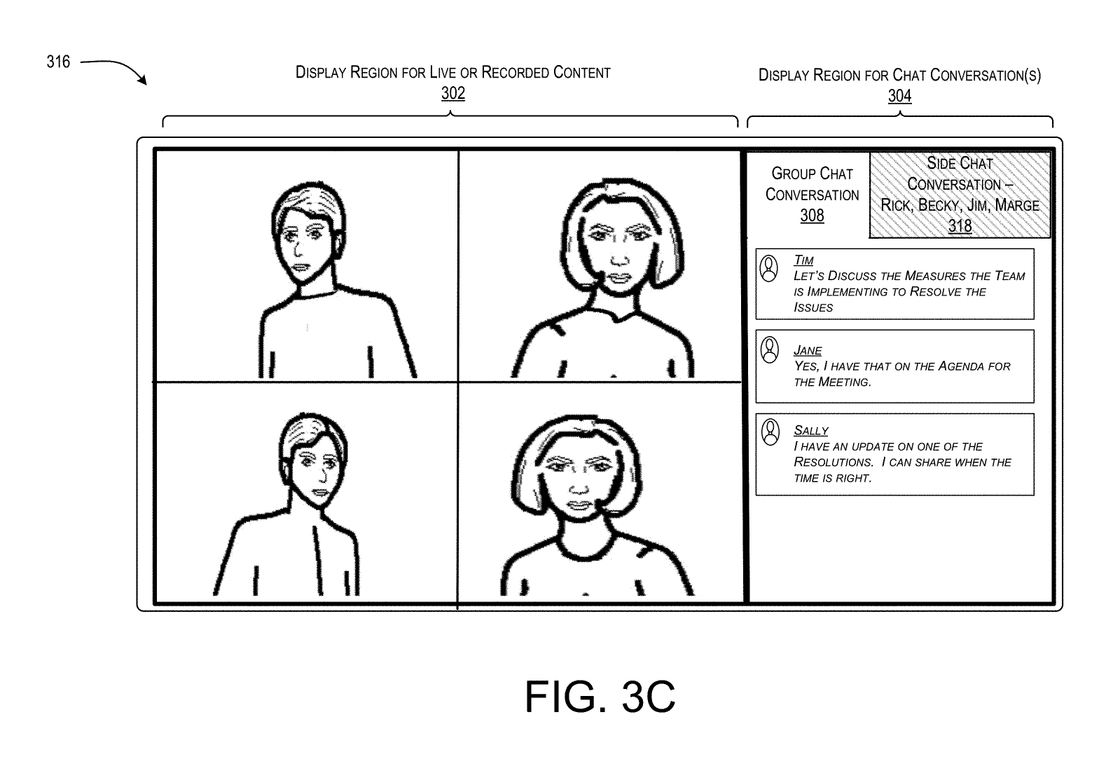

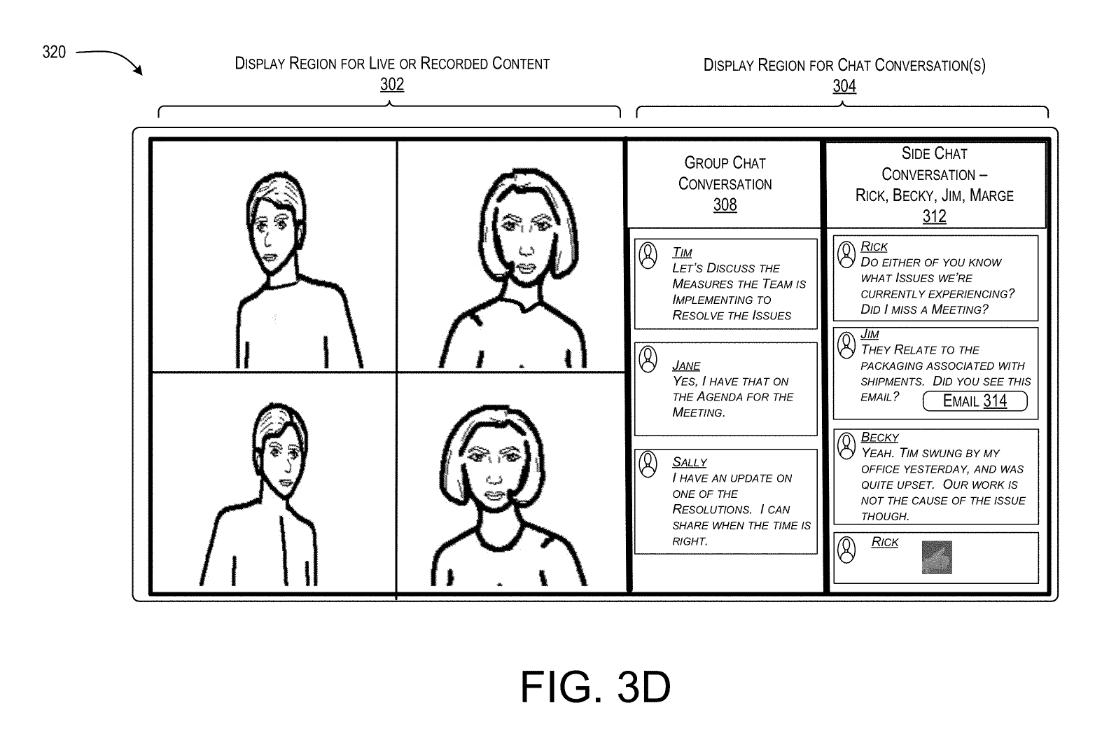

FIG. 3A illustrates an example graphical user interface 300 that includes a display region 302 for live or recorded content of a conference session and a display region 304 for chat conversation(s) of the conference session (e.g., also referred to herein as a chat display region). As shown, the display region 304 includes an option (e.g., a tab) to start a side chat conversation 306. In this example view, a group chat conversation 308 is displayed in the display region 304 while a user is engaged with the live or recorded content (e.g., viewing the live or recorded content). As described above, the group chat conversation 308 is accessible by all the users participating in the conference session via a live or recorded viewing, and thus, any information and/or activity shared via the group chat conversation can be seen by everyone (e.g., the comments submitted by Tim, Jane, and Sally can be viewed by all the users participating in the conference session).

In the example of FIG. 3A, the live or recorded content in the display region 302 illustrates a view in which four different audio/visual streams of four different users are displayed in separate cells (e.g., four grid cells). However, other views of content can be implemented in association with the techniques and examples described herein. A “view” comprises a configuration and/or a layout of content of the conference session. Thus, a different view can include an individual person speaking (e.g., a team leader informing his or her team of new procedures, etc.). Moreover, in an alternative view, file content can be displayed rather than a video feed of a person. Consequently, content of a conference session can be displayed in multiple different views.

FIG. 3B illustrates an example graphical user interface 310 that illustrates an example of how a side chat conversation 312 is displayed in response to a user selecting the option to start the side chat conversation 306, as illustrated in FIG. 3A. Upon selection of the option to start the side chat conversation 306, a request is sent to the conversation module 146. The request designates individual users that are to receive access to the side chat conversation 312, and any communications submitted thereto. Accordingly, in this example, upon selecting the option to start the side chat conversation 306, a user named Rick provides input that designates a subset of users named Becky, Jim, and Marge as users with permissions to access the side chat conversation 312. Accordingly, other users participating in the conference session that are not designated, such as Tim, Jane, and Sally (from FIG. 3A), are unable to access the side chat conversation 312 and communications submitted thereto.

Rick may have requested to start the side chat conversation 312 because he wants to discuss some details or items in private. Perhaps he is unaware of the issues introduced by Tim in the group chat conversation 308 of FIG. 3A (e.g., Tim may be the team leader or a supervisor) and he should be aware of the issues. Consequently, Rick may want to contact co-workers he knows well and/or with which he is more comfortable, asking in the first listed communication of the side chat conversation 312 “Do either of you know what issues we're currently experiencing? Did I miss a meeting?”. As shown, Jim and Becky each respond with a communication—Jim stating that “They relate to packaging associated with shipments” and then Jim asks Rick “Did you see this email?”. Attached to Jim's communication is an email 314 that explains the issues being experienced. In response to Becky's communication, Rick submits another communication in which an expression (e.g., a thumbs-up) is shared. Thus, as illustrated in FIG. 3B, different types of information and/or activity can be shared via communications submitted to the side chat conversation 312 (e.g., messages/comments, files such as an email, expressions, etc.).

As shown in FIG. 3B, Rick can switch between viewing the group chat conversation 308 and/or viewing the side chat conversation 312 within the display region 304 based on selection of a tab corresponding to one of the chat conversations.

FIG. 3C illustrates an example graphical user interface 316 that illustrates an example of how a user is notified of a side chat conversation. This graphical user interface 316 is being viewed by a user other than the user that requests that the side chat conversation be started (e.g., Becky, Jim, or Marge). As shown, upon generation of the side chat conversation and/or a communication submitted thereto (e.g., the first communication from Rick as illustrated in FIG. 3B), the conversation module 146 can populate the display region 304 with a tab 318, selection of which enables the viewer to access the side chat conversation. In some examples, the tab 318 can include a visual distinction (e.g., changing colors of the tab 318, flashing the tab 318, fill or pattern within the tab 318, etc.) to notify the user of the creation of the side chat conversation and to attract the user's attention. As described above, Becky, Jim, or Marge can switch between viewing the group chat conversation 308 and/or viewing the side chat conversation within the display region 304 based on selection of a tab corresponding to one of the chat conversations.

FIG. 3D illustrates an example graphical user interface 320 that illustrates another example of how a side chat conversation 312 can be displayed in response to a user selecting the option to start the side chat conversation 306, as illustrated in FIG. 3A. Here, the group chat conversation 308 and the side chat conversation 312 are configured adjacent to one another within the display region (e.g., a side-by-side view of multiple chat conversations). In this way, a user such as Ricky, Becky, Jim, or Marge can view both chat conversations being conducted in association with the live or recorded content of the conference session.

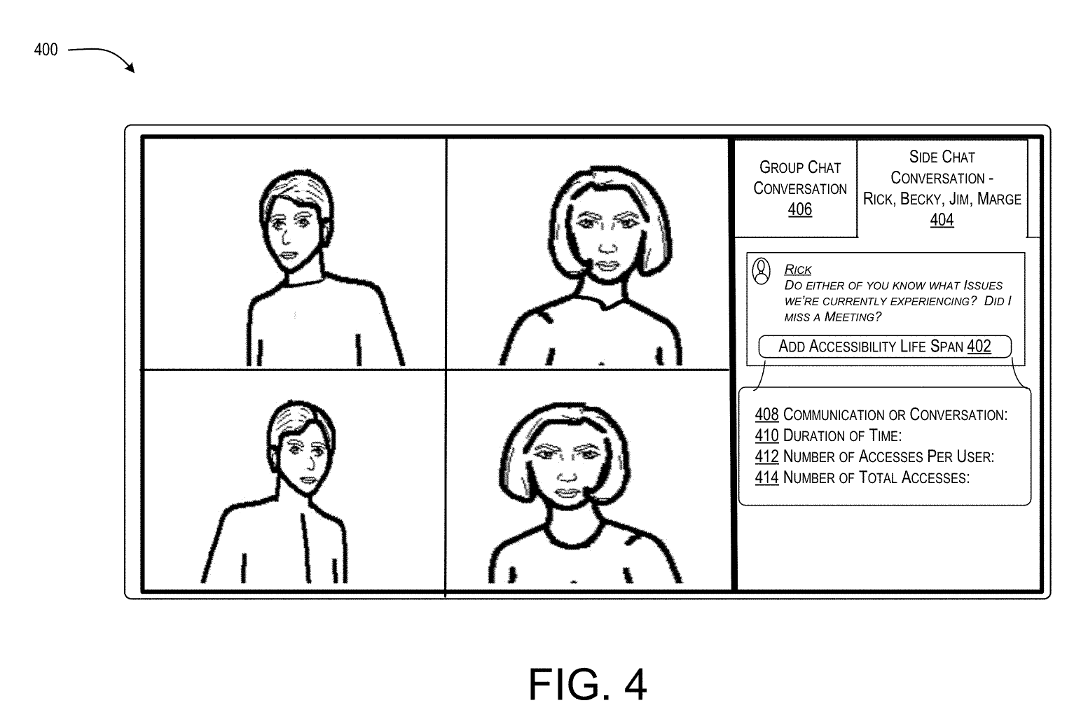

FIG. 4 illustrates an example graphical user interface 400 in which a user is provided with an option to add an accessibility life span 402 to a side chat conversation 404 and/or an individual communication submitted to the side chat conversation 404. Similar to the examples described above with respect to FIGS. 3A-3D, a chat display region includes a tab that provides access to a group chat conversation 406, in addition to the side chat conversation 404.

As described above, the system may comprise a tool (e.g., a module) to track activity that occurs within a conference session and add the activity to a historic record (e.g., an interactive timeline and/or a transcript). However, there may be some situations, where a user does not want the side chat conversation and/or a communication submitted thereto to become part of the historic record for an extended period of time. Accordingly, upon starting the side chat conversation 404 with Becky, Jim, and Marge, Rick can be presented with an option to associate an accessibility life span 402 with the side chat conversation and/or an individual communication. Upon selection of the option, Rick can choose between adding the accessibility life span to an individual communication or to the side chat conversation 408. Moreover, Rick can select a type of an accessibility life span. For example, Rick can provide input that defines a duration of time 410 (e.g., one minute, five minutes, twenty minutes, two days, two months, etc.) for which the side chat conversation and/or the individual communication can be accessed. In another example, Rick can provide input that defines a number of times 412 the side chat conversation and/or the individual communication can be accessed by individual users. In yet another example, Rick can provide input that defines a total number of times 414 the side chat conversation and/or the individual communication can be accessed by any of the subset of users designated to access the side chat conversation.

Accordingly, the conversation module 146 is configured to track information corresponding to the accessibility life span (e.g., duration of time, number of accesses and by who, etc.) and determine when the accessibility life span has expired (e.g., reached its limit). Upon expiration of the accessibility life span, further access to the side chat conversation and/or the communication by the subset of users is prohibited by the conversation module 146. In some examples, the side chat conversation and/or the individual communication are deleted from the historic record upon expiration of the accessibility life span.

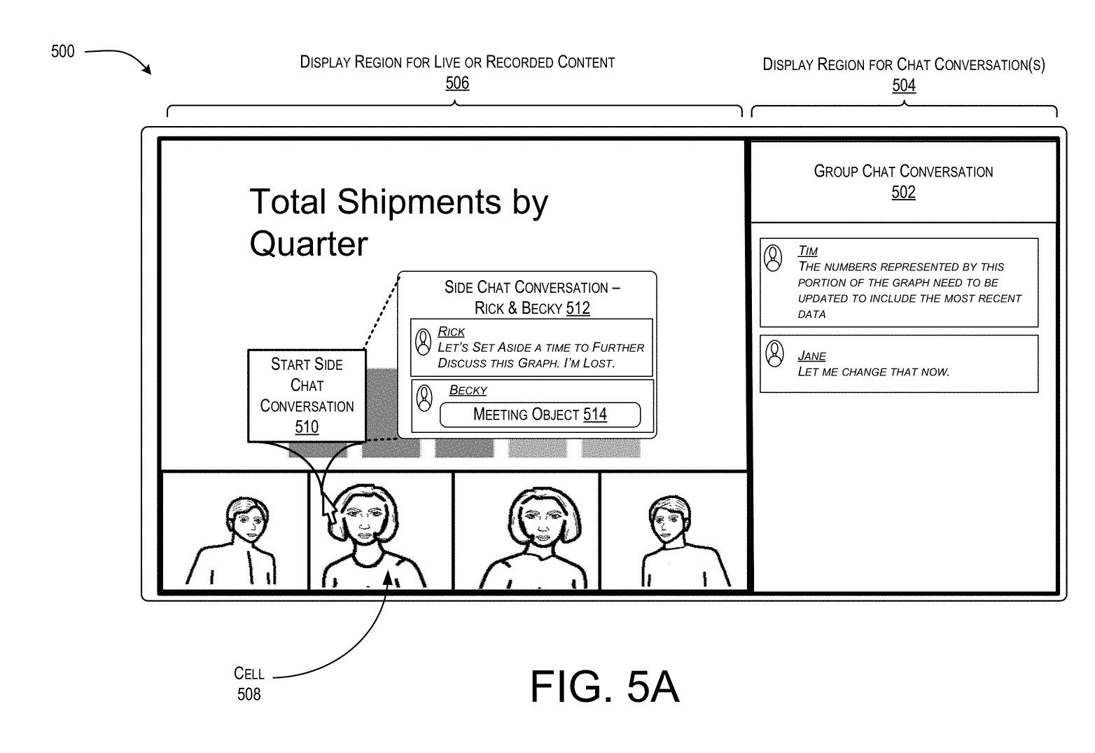

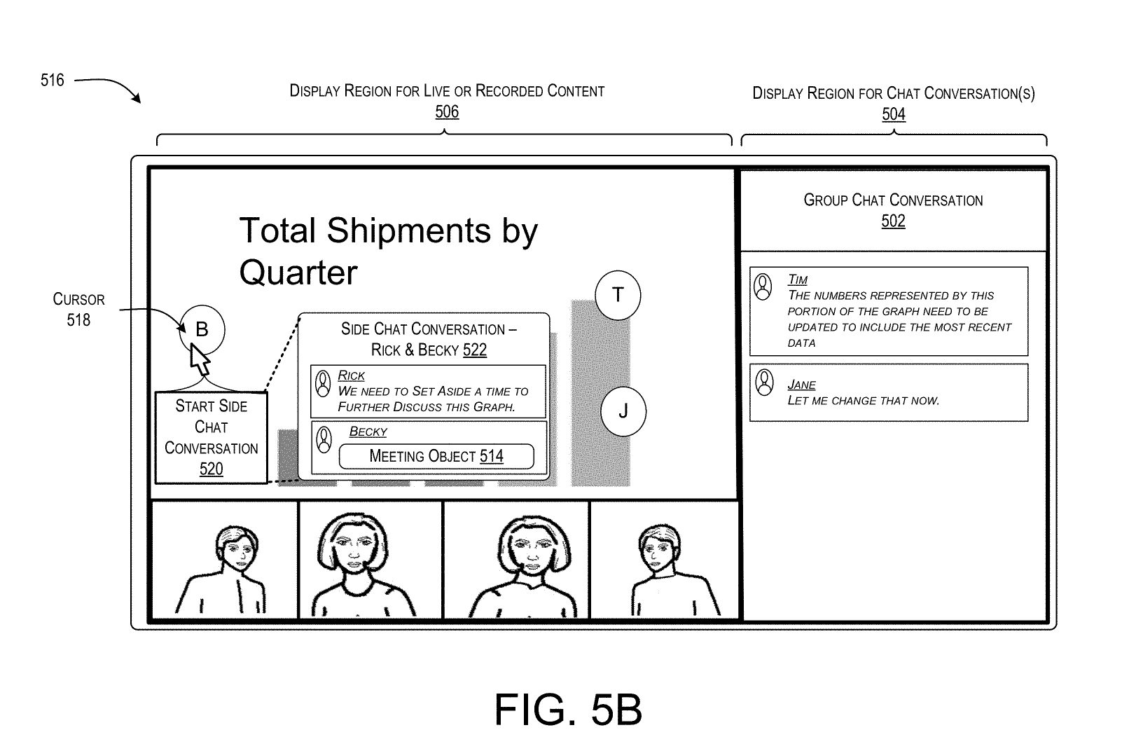

FIG. 5A illustrates an example graphical user interface 500 that illustrates another example of how a user can start a side chat conversation with another user to perform private communications. In this example view, a group chat conversation 502 is displayed in the display region 504 while a user is engaged with the live or recorded content (e.g., viewing the live or recorded content) displayed in the display region 506. However, in alternative examples, the display region 504 for chat conversations is not displayed, and the display region 506 consumes most or all of the user interface associated with the conference session. The content includes file content that depicts a graph of “Total Shipments by Quarter” in a primary stage, as well as cells that include streams associated with four users in a secondary stage at the bottom of the graphical user interface.

Here, the user (e.g., Rick) can perform a direct interaction with displayed content associated with the other user (e.g., Becky) to start the side conversation. For example, Rick can provide input (e.g., a right click) on a cell 508 that includes a stream associated with Becky (e.g., an audio/visual stream, and audio stream with an avatar, etc.). Upon providing the input, Rick is presented with an option to start a side chat conversation 510 with Becky (e.g., the user associated with the clicked-on cell), and upon selection of the option 510, a pop up window that includes the side chat conversation 512 is displayed. Consequently, Rick is enabled to submit a private communication to the side chat conversation 512, which states “Let's set aside a time to further discuss this graph. I'm lost.”. In response, Becky submits a communication to the side chat conversation that shares a link to a meeting object 514 that Rick can add to his calendar to discuss the graph with Becky. In various examples, the conversation module 146 is configured to temporarily display the pop up window for a defined period of time after a user submits a communication to the side chat conversation (e.g., the pop up window is displayed to Rick for ten seconds after Becky responds to Rick's communication). After the temporary display, the side chat conversation 512 can be configured in the display region 504 so Rick's view of the live or recorded content is not distracted for an extended period of time. In some instances, the pop up window is graphically associated with a user that is a source of a communication submitted to the side chat conversation.

FIG. 5B illustrates an example graphical user interface 516 that illustrates another example of how a user can start a side chat conversation with another user to perform private communications. In this example, users participating in the conference session are each associated with a cursor on the user interface 516 (e.g., the T cursor is associated with Tim, the J cursor is associated with Jane, the B cursor is associated with Becky, etc.) so the users can view each other's movement and interactions with the displayed file content. The users may be performing a group edit of a slide deck, for example. Here, Rick can provide input (e.g., a right click) on the cursor 518 associated with Becky. Upon providing the input, Rick is presented with an option to start a side chat conversation 520 with Becky, and upon selection of the option 520, a pop up window that includes the side chat conversation 522 is displayed. Similar to the discussion above, Rick is enabled to submit a private communication to the side chat conversation 522, and Becky can provide a response communication that includes the meeting object 514.

In various examples, a subset of users can use a side chat conversation to privately discuss a portion of a file (e.g., a slide deck) that they are tasked with presenting or editing prior to the portion of the file being displayed to the larger group. Thus, communications submitted and shared through the side chat conversation enable the subset of users to organize their presentation or edits and be more productive, without distracting the larger group participating in the conference session.

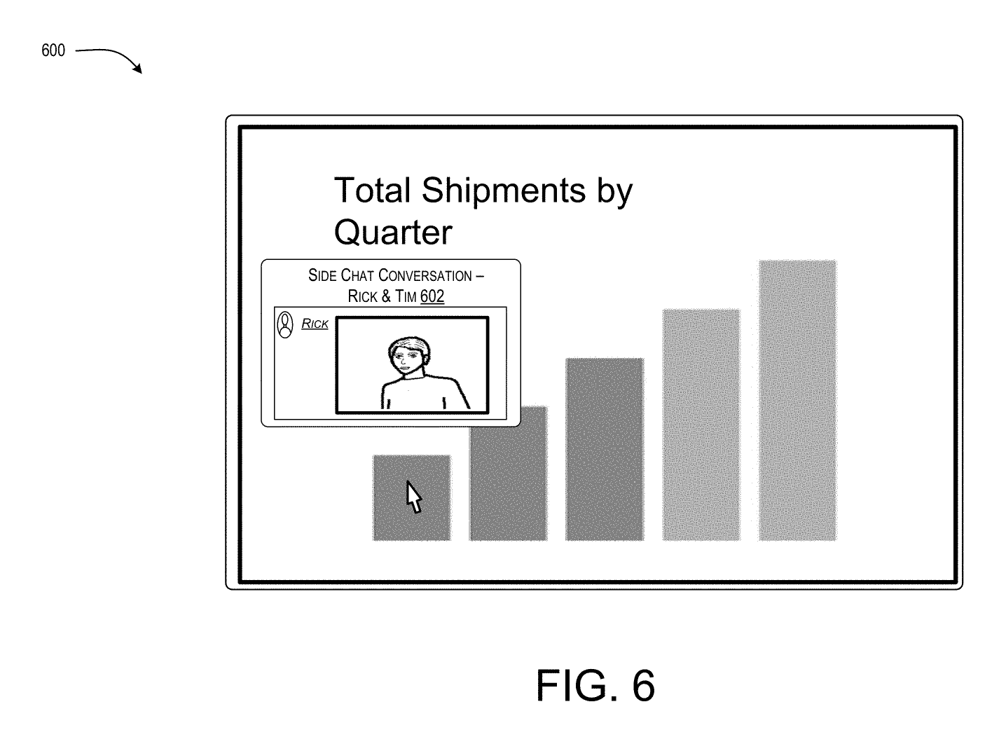

FIG. 6 illustrates an example graphical user interface 600 that illustrates a video that is shared via a side chat conversation 602. As described above, communications submitted to a side chat conversation can include a video. In the example of FIG. 6, the team leader Tim may be presenting a slide deck about confidential shipping information, and one of the team members Rick shares with him a private communication via the side chat conversation 602. For example, in the video, Rick may verbally communicate, in private, that he thinks the conference session includes some participants that are not supposed to be privy to some of the confidential shipping information being presented, and as a result, Tim should skip over some slides and/or ask the participants to leave the conference session.

In various examples, to notify a viewer of a side chat conversation, the pop up windows described herein or more general notifications of a new side chat conversation started and/or a new communication submitted to a side chat conversation, can be displayed by a client computing device. A pop up window and/or a notification can be associated with a high priority such that the client computing device displays the pop up window or the notification on top of any application windows on a display screen to make the viewer aware of the side chat conversation.

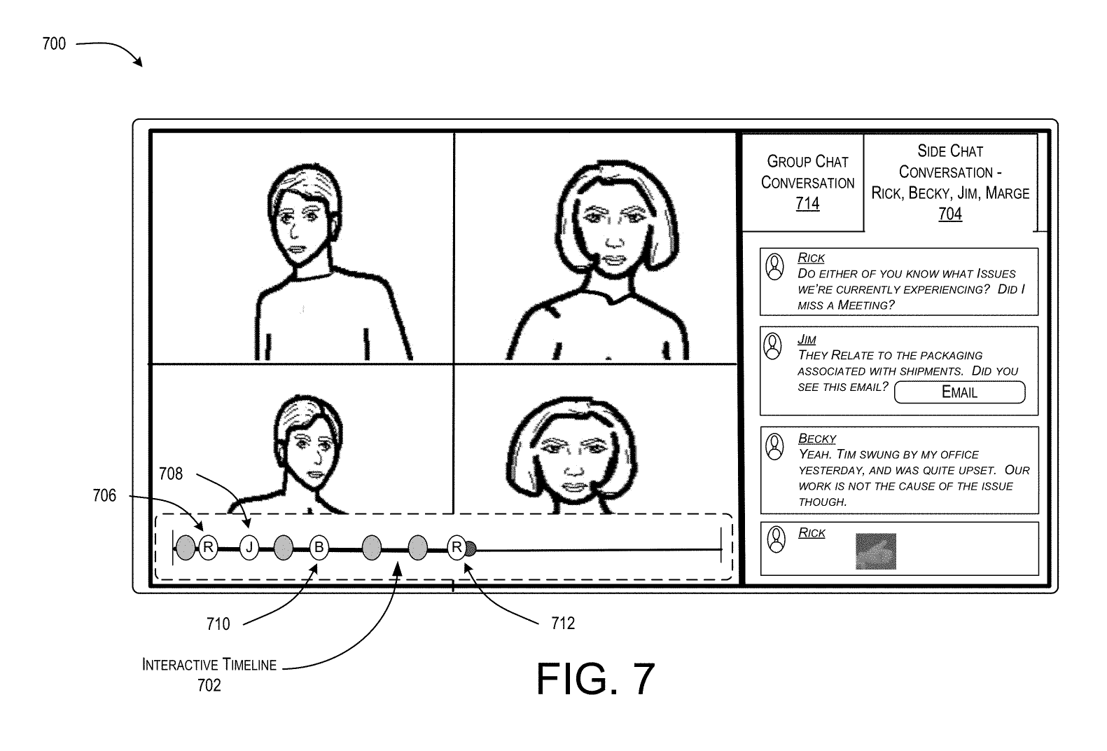

FIG. 7 illustrates an example graphical user interface 700 configured to display an interactive timeline 702 with representations of communications submitted to a side chat conversation 704 (e.g., the same side chat conversation 312 illustrated in FIG. 3B).

An interactive timeline is configured to display representations of notable events. The notable events can include the communications submitted to the side chat conversation 704. Accordingly, the conversation module 146 is configured to enable access to a communication submitted to a side chat conversation 704 by adding a representation of the communication to the interactive timeline 702 associated with the conference session. As shown, the first communication submitted by Rick to the side chat conversation 704 is reflected via the representation 706. The second communication submitted by Jim to the side chat conversation 704 is reflected via the representation 708. The third communication submitted by Becky to the side chat conversation 704 is reflected via the representation 710. And the fourth communication submitted by Rick to the side chat conversation 704 is reflected via the representation 712.

As described above, the interactive timeline 702 is configured to display representations of various types of activity (e.g., notable events) that occurs in the conference session and that contributes to understanding a context of the conference session. This includes activity that occurs in the live or recorded content displayed, as well as activity that occurs in the group chat conversation 714, for example. Accordingly, the interactive timeline 702 can be configured to visually (e.g., graphically) distinguish between communications submitted to the side chat conversation 704 and other activity that occurs outside the side chat conversation 604 (e.g., via color of representations, via size of representations, via pattern or fill of representations, via labels of representations, etc.). As shown, the interactive timeline 702 includes other representations that are not associated with the communications submitted to the side chat conversation 704. These other representations can be accessed by all the users participating in the conference session, and are therefore visually distinguished from the representations 706, 708, 710, 712 associated with the communications submitted to the side chat conversation 704. In this way, an individual user participating in the conference session is provided with a personalized interactive timeline based on an extent of the user's involvement in one or more different side chat conversation(s) that include private communications.

In various examples, two or more interactive timelines can be displayed—a first interactive timeline associated with the activity that is accessible by all the users participating in the conference session and one or more additional interactive timelines associated with activity that is only accessible to a subset of users via side chat conversation(s). Accordingly, a historic record (e.g., an object) associated with the side chat conversation can be reflected via its own interactive timeline. In some instances, a setting can define that the historic record of the side chat conversation is associated with a default accessibility life span (e.g., a default duration of time, a default number of accesses per user, a default number of total accesses, etc.), expiration of which prevents further access and/or deletes the historic record (e.g., deletes the side chat conversation object within the conference session).

Upon seeing the representation (e.g., representation 706) and performing an interaction (e.g., a hover input, a click or selection, etc.) with the representation, a user designated to access the communication can view the communication (e.g., a message, a shared file, a shared link to an object, a video, etc.). The interactive timeline 702 with representations of private communications can be particularly useful in example scenarios where chat conversations are not displayed (e.g., the user interface is not configured with a chat display region that displays the group chat conversation 714 or the side chat conversation 704).

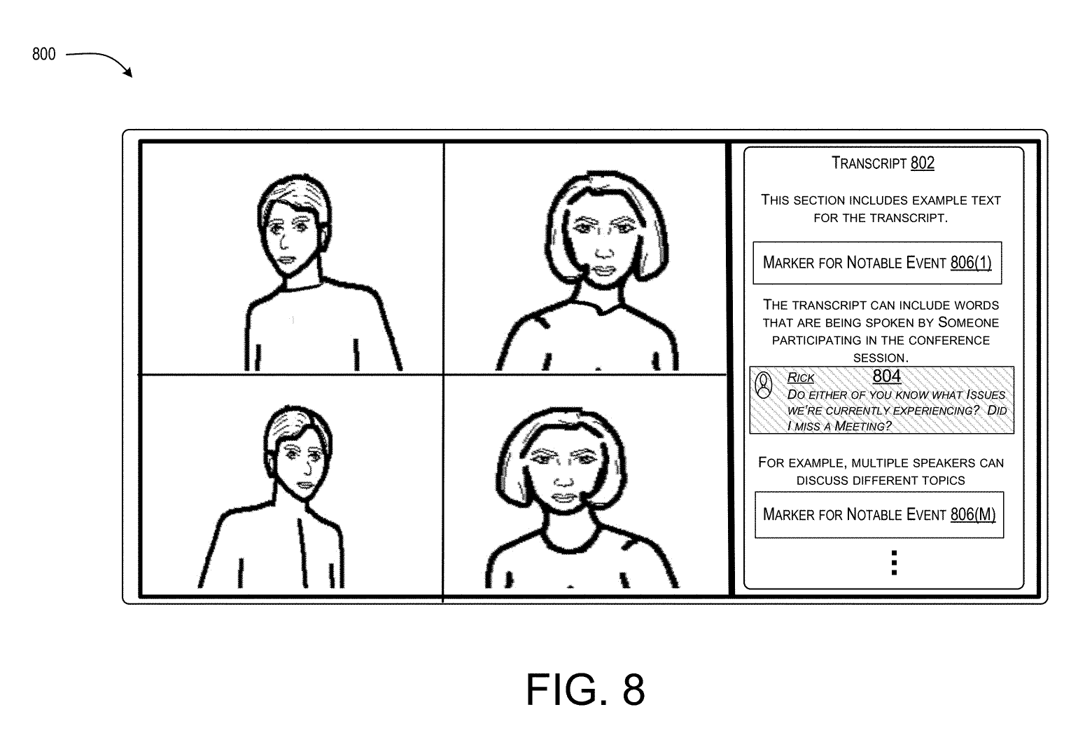

FIG. 8 illustrates an example graphical user interface 800 configured to display a transcript 802 that includes a marker 804 associated with a communication submitted to a side chat conversation. In this example, the marker 804 describes Rick's first communication in the side chat conversation 704 of FIG. 7.

The transcript 802 can include text reflecting words spoken during the conference session. As described above, a portion or snippet of the text can be associated with a timestamp that indicates when the text was spoken with respect to a point of playback of the live or recorded content. The transcript 802 can also include markers 806(1) through 806(M) (where M is a positive integer number) that describe notable events that occur in the conference session outside of a side chat conversation. The markers 804 and 806(1) through 806(M) can be interspersed within the text based on a time of occurrence with respect to the live or recorded content being played back. The transcript 802 is populated with the text and/or markers 804 and 806(1) through 806(M) as the words are spoken and as the activity occurs. Thus, as new material is added, older material may be pushed up and off the graphical user interface 800. To enable a viewer to look back and locate text and/or markers that previously occurred, the transcript 802 can be a scrollable transcript via the use of a scroll bar.

In various examples, the transcript 802 is configured to visually (e.g., graphically) distinguish between markers corresponding to communications submitted to a side chat conversation and markers corresponding to other activity that occurs outside the side chat conversation (e.g., via color of markers, via size of markers, via pattern or fill of markers, etc.). In this way, an individual user participating in the conference session is provided with a personalized transcript based on an extent of the user's involvement in one or more different side chat conversation(s) that include private communications.

In scenarios where an entire communication is not contained in a marker, a user can perform an interaction (e.g., a hover input, a click or selection, etc.) with the marker to access additional information in the communication. The transcript with markers describing private communications can also be particularly useful in example scenarios where chat conversations are not displayed.

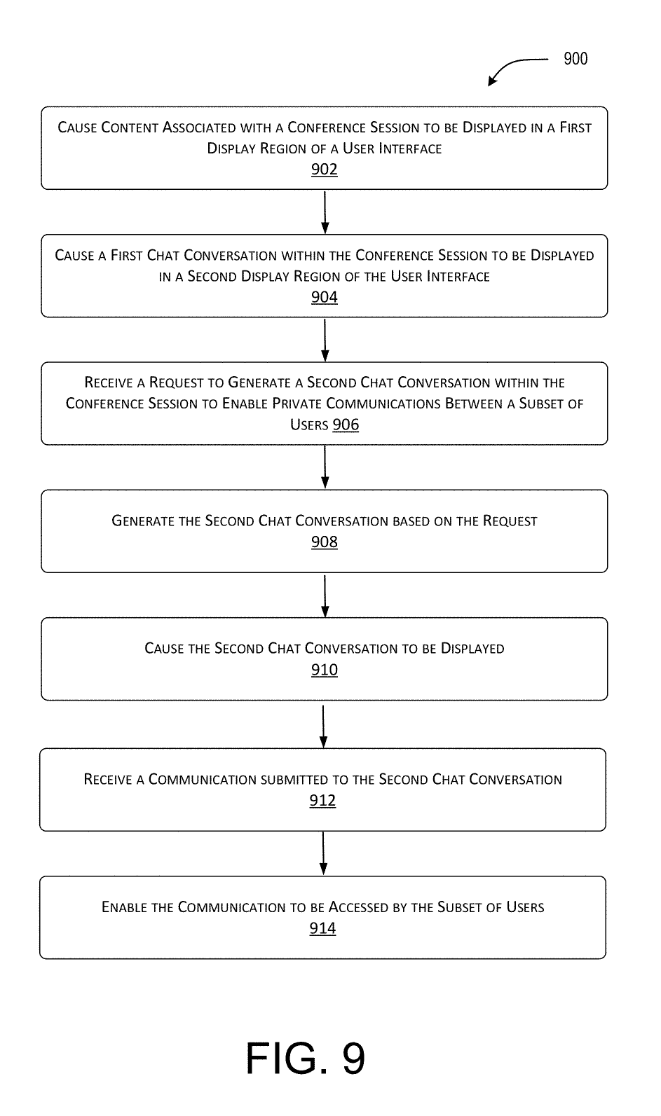

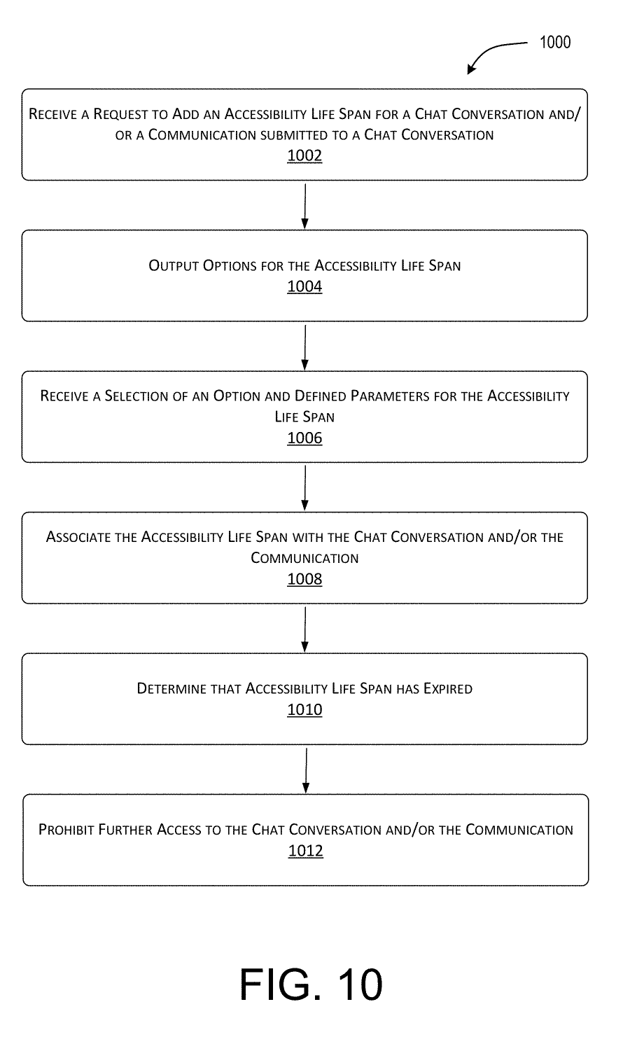

FIGS. 9 and 10 illustrate example flowcharts. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It also should be understood that the illustrated methods can end at any time and need not be performed in their entirety. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system (e.g., device 110, client computing device 106(N), and/or device 200) and/or (2) as interconnected machine logic circuits or circuit modules within the computing system.

Additionally, the operations illustrated in FIGS. 9 and/or 10 can be implemented in association with the example graphical user interfaces described above with respect to FIGS. 3A-8. For instance, the various device(s) and/or module(s) in FIGS. 1 and/or 2 can generate, transmit, receive, and/or display data associated with content of a conference session (e.g., live content, recorded content, etc.), chat conversations, interactive timelines, and/or transcripts.

FIG. 9 is a diagram of an example flowchart 900 that illustrates operations directed to generating a side chat conversation to enable access to private communications. In one example, the operations of FIG. 9 can be performed by components of the system 102 and/or a client computing device 106(N).

At operation 902, content associated with a conference session is caused to be displayed in a first display region of a user interface.

At operation 904, content of a first chat conversation (e.g., a group chat conversation accessible to all the users participating in the conference session) is caused to be displayed in a second display region of the user interface.

At operation 906, a request to a generate a second chat conversation (e.g., a side chat conversation) within the conference session is received. The second chat conversation enables private communications between some but not all of the users participating in the conference session (e.g., a subset of users).

At operation 908, the second chat conversation is generated based on the request.

At operation 910, the second chat conversation is caused to be displayed. For example, the second chat conversation can be configured for display in the second display region along with the first chat conversation (e.g., via a tabbed view format, via an adjacent view format, etc.). In another example, the second chat conversation can be displayed in a pop up window.

At operation 912, a communication that has been submitted to the second chat conversation is received.

At operation 914, the communication is enabled to be accessed by the subset of users. For example, the side chat conversation that includes the communication can be added to a chat display region configured to be displayed to a user designated to access the side chat conversation. In another example, the side chat conversation that includes the communication can be included in a pop up window that is configured to be displayed to the user designated to access the side chat conversation. In yet another example, a representation of the communication can be added to an interactive timeline configured to be displayed to a user designated to access the side chat conversation. In even a further example, a marker associated with the communication can be added to a transcript that is configured to be displayed to a user designated to access the side chat conversation. In some instances, a notification of the side chat conversation and/or a communication can be displayed to a user designated to access the side chat conversation.

FIG. 10 is a diagram of an example flowchart 1000 that illustrates operations directed to using an accessibility life span to limit access to a chat conversation and/or a communication submitted to a chat conversation. In one example, the operations of FIG. 10 can be performed by components of the system 102 and/or a client computing device 106(N).

At operation 1002, a request to add an accessibility life span for a chat conversation and/or a communication submitted to the chat conversation is received.

At operation 1004, options to define a type of accessibility life span are output.

At operation 1006, a selection of an option is received along with defined parameters for the accessibility life span (e.g., a duration of time, a number of accesses per user, a total number of accesses, etc.).

At operation 1008, the accessibility life span is associated with the chat conversation and/or the communication submitted to the chat conversation.

At operation 1010, it is determined that the accessibility life span has expired (e.g., reached its limit).

At operation 1012, further access to the chat conversation and/or the communication is prohibited.

In alternative examples, a setting can define that the side chat conversation is associated with a default accessibility life span, such that the historic record of the side chat conversation is no longer accessible after expiration of the default accessibility life span (e.g., the historic record of the side chat conversation is deleted from the conference session).

The disclosure presented herein may be considered in view of the following example clauses.

Example A, a system comprising: one or more processing units; and a computer-readable medium having encoded thereon computer-executable instructions to cause the one or more processing units to: cause content of a conference session to be displayed via a client computing device, the conference session including a plurality of users; cause a first chat conversation included within the conference session to be displayed via the client computing device; receive, from the client computing device, a request to generate a second chat conversation within the conference session, the second chat conversation between a subset of users of the plurality of users, the request identifying individual ones of the subset of users; generate, based at least in part on the request, the second chat conversation; cause the second chat conversation included within the conference session to be displayed via the client computing device; receive, from the client computing device, a communication submitted to the second chat conversation; and enable the communication to be accessed by the subset of users via the second chat conversation.

Example B, the system of Example A, wherein the second chat conversation is a private chat conversation such that individual users of the plurality of users other than the subset of users are unable to access communications shared via the second chat conversation.

Example C, the system of Example A or Example B, wherein at least one of the second chat conversation or the communication is associated with an accessibility life span, the computer-executable instructions further causing the one or more processing units to prohibit further access, by the subset of users, to the at least one of the second chat conversation or the communication upon expiration of the accessibility life span.

Example D, the system of Example C, wherein the accessibility life span comprises one of: a defined duration for accessing the at least one of the second chat conversation or the communication; a defined number of times the at least one of the second chat conversation or the communication can be accessed by individual ones of the subset of users; or a defined total number of times the at least one of the second chat conversation or the communication can be accessed by the subset of users.

Example E, the system of any one of Examples A through D, wherein the communication comprises one or more of a message, a file, an expression, a video, or a link to an object.

Example F, the system of any one of Examples A through E, wherein enabling the communication to be accessed by the subset of users via the second chat conversation comprises causing the second chat conversation to be displayed in a pop up window that overlays the content of the conference session.

Example G, the system of any one of Examples A through E, wherein enabling the communication to be accessed by the subset of users via the second chat conversation comprises causing the second chat conversation to be displayed in a chat display region of a user interface, wherein the chat display region is configured to switch between displaying the first chat conversation and displaying the second chat conversation based at least in part on selection of a tab.

Example H, the system of any one of Examples A through E, wherein enabling the communication to be accessed by the subset of users via the second chat conversation comprises causing the second chat conversation to be displayed in a chat display region of a user interface, wherein the chat display region is configured to concurrently display the first chat conversation and the second chat conversation.

Example I, the system of any one of Examples A through E, wherein enabling the communication to be accessed by the subset of users via the second chat conversation comprises adding a representation of the communication to an interactive timeline of the conference session, the communication being accessible by individual ones of the subset of users via the representation added to the interactive timeline.

Example J, the system of any one of Examples A through E, wherein enabling the communication to be accessed by the subset of users via the second chat conversation comprises adding a marker associated with the communication to a transcript of the conference session, the communication being accessible by individual ones of the subset of users via the marker added to the transcript.

While Examples A through J are described above with respect to a system, it is understood in the context of this document that Examples A through J can additionally or alternatively be implemented as a method, by a device, and/or via computer-readable storage media.

Example K, a method comprising: causing content of a conference session to be displayed via a client computing device, the conference session including a plurality of users; causing a first chat conversation included within the conference session to be displayed via the client computing device; receiving, from the client computing device, a request to generate a second chat conversation within the conference session, the second chat conversation between a subset of users of the plurality of users, the request identifying individual ones of the subset of users; generating, based at least in part on the request, the second chat conversation; causing the second chat conversation included within the conference session to be displayed via the client computing device; receiving, from the client computing device, a communication submitted to the second chat conversation; and enabling the communication to be accessed by the subset of users via the second chat conversation.

Example L, the method of Example K, wherein at least one of the second chat conversation or the communication is associated with an accessibility life span, the method further comprising prohibiting further access, by the subset of users, to the at least one of the second chat conversation or the communication upon expiration of the accessibility life span, wherein the accessibility life span comprises one of: a defined duration for accessing the at least one of the second chat conversation or the communication; a defined number of times the at least one of the second chat conversation or the communication can be accessed by individual ones of the subset of users; or a defined total number of times the at least one of the second chat conversation or the communication can be accessed by the subset of users.

Example M, the method of Example K or Example L, wherein enabling the communication to be accessed by the subset of users via the second chat conversation comprises causing the second chat conversation to be displayed in a pop up window that overlays the content of the conference session.

Example N, the method of Example K or Example L, wherein enabling the communication to be accessed by the subset of users via the second chat conversation comprises causing the second chat conversation to be displayed in a chat display region of a user interface, wherein the chat display region is configured to switch between displaying the first chat conversation and displaying the second chat conversation based at least in part on selection of a tab.

Example O, the method of Example K or Example L, wherein enabling the communication to be accessed by the subset of users via the second chat conversation comprises causing the second chat conversation to be displayed in a chat display region of a user interface, wherein the chat display region is configured to concurrently display the first chat conversation and the second chat conversation.

Example P, the method of Example K or Example L, wherein enabling the communication to be accessed by the subset of users via the second chat conversation comprises adding a representation of the communication to an interactive timeline of the conference session, the communication being accessible by individual ones of the subset of users via the representation added to the interactive timeline.

Example Q, the method of Example K or Example L, wherein enabling the communication to be accessed by the subset of users via the second chat conversation comprises adding a marker associated with the communication to a transcript of the conference session, the communication being accessible by individual ones of the subset of users via the marker added to the transcript.

While Examples K through Q are described above with respect to a method, it is understood in the context of this document that Examples K through Q can additionally or alternatively be implemented by a system, by a device, and/or via computer-readable storage media.

Example R, a system comprising: one or more processing units; and a computer-readable medium having encoded thereon computer-executable instructions to cause the one or more processing units to: cause content of a conference session to be displayed via a client computing device; cause a chat conversation included within the conference session to be displayed via the client computing device; receive, from the client computing device, a communication submitted to the chat conversation; receive, from the client computing device, an accessibility life span associated with the communication; enable access to the communication for one or more users participating in the conference session; determine that the accessibility life span associated with the communication has expired; and based on determining that the accessibility life span associated with the communication has expired, prohibit further access to the communication for the one or more users.

Example S, the system of Example R, wherein the accessibility life span comprises one of: a defined duration for accessing the communication; a defined number of times the communication can be accessed by individual ones of the one or more users; or a defined total number of times the communication can be accessed by the one or more users.

Example T, the system of Example R or Example S, wherein the chat conversation comprises a side chat conversation in which the one or more users are enabled to exchange private communications.

While Examples R through T are described above with respect to a system, it is understood in the context of this document that Examples R through T can additionally or alternatively be implemented as a method, by a device, and/or via computer-readable storage media.

Although the techniques have been described in language specific to structural features and/or methodological acts, it is to be understood that the appended claims are not necessarily limited to the features or acts described. Rather, the features and acts are described as example implementations of such techniques.

The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A system comprising:
one or more processing units; and
a computer-readable medium having encoded thereon computer-executable instructions to cause the one or more processing units to:
cause content of a conference session to be displayed via a client computing device, the conference session including a plurality of users;
cause a first chat conversation included within the conference session to be displayed via the client computing device;
receive, from the client computing device, a request to generate a second chat conversation within the conference session, the second chat conversation between a subset of users of the plurality of users, the request identifying individual ones of the subset of users;
generate, based at least in part on the request, the second chat conversation;
cause the second chat conversation included within the conference session to be displayed via the client computing device;
receive, from the client computing device, a communication submitted to the second chat conversation; and
enable the communication to be accessed by the subset of users via the second chat conversation.

2. The system of claim 1, wherein the second chat conversation is a private chat conversation such that individual users of the plurality of users other than the subset of users are unable to access communications shared via the second chat conversation.

3. The system of claim 1, wherein at least one of the second chat conversation or the communication is associated with an accessibility life span, the computer-executable instructions further causing the one or more processing units to prohibit further access, by the subset of users, to the at least one of the second chat conversation or the communication upon expiration of the accessibility life span.

4. The system of claim 3, wherein the accessibility life span comprises one of:
a defined duration for accessing the at least one of the second chat conversation or the communication;
a defined number of times the at least one of the second chat conversation or the communication can be accessed by individual ones of the subset of users; or
a defined total number of times the at least one of the second chat conversation or the communication can be accessed by the subset of users.

5. The system of claim 1, wherein the communication comprises one or more of a message, a file, an expression, a video, or a link to an object.

6. The system of claim 1, wherein enabling the communication to be accessed by the subset of users via the second chat conversation comprises causing the second chat conversation to be displayed in a pop up window that overlays the content of the conference session.

7. The system of claim 1, wherein enabling the communication to be accessed by the subset of users via the second chat conversation comprises causing the second chat conversation to be displayed in a chat display region of a user interface, wherein the chat display region is configured to switch between displaying the first chat conversation and displaying the second chat conversation based at least in part on selection of a tab.

8. The system of claim 1, wherein enabling the communication to be accessed by the subset of users via the second chat conversation comprises causing the second chat conversation to be displayed in a chat display region of a user interface, wherein the chat display region is configured to concurrently display the first chat conversation and the second chat conversation.

9. The system of claim 1, wherein enabling the communication to be accessed by the subset of users via the second chat conversation comprises adding a representation of the communication to an interactive timeline of the conference session, the communication being accessible by individual ones of the subset of users via the representation added to the interactive timeline.

10. The system of claim 1, wherein enabling the communication to be accessed by the subset of users via the second chat conversation comprises adding a marker associated with the communication to a transcript of the conference session, the communication being accessible by individual ones of the subset of users via the marker added to the transcript.

11. A method comprising:
causing content of a conference session to be displayed via a client computing device, the conference session including a plurality of users;
causing a first chat conversation included within the conference session to be displayed via the client computing device;
receiving, from the client computing device, a request to generate a second chat conversation within the conference session, the second chat conversation between a subset of users of the plurality of users, the request identifying individual ones of the subset of users;
generating, based at least in part on the request, the second chat conversation;
causing the second chat conversation included within the conference session to be displayed via the client computing device;
receiving, from the client computing device, a communication submitted to the second chat conversation; and
enabling the communication to be accessed by the subset of users via the second chat conversation.

12. The method of claim 11, wherein at least one of the second chat conversation or the communication is associated with an accessibility life span, the method further comprising prohibiting further access, by the subset of users, to the at least one of the second chat conversation or the communication upon expiration of the accessibility life span, wherein the accessibility life span comprises one of:
a defined duration for accessing the at least one of the second chat conversation or the communication;
a defined number of times the at least one of the second chat conversation or the communication can be accessed by individual ones of the subset of users; or
a defined total number of times the at least one of the second chat conversation or the communication can be accessed by the subset of users.

13. The method of claim 11, wherein enabling the communication to be accessed by the subset of users via the second chat conversation comprises causing the second chat conversation to be displayed in a pop up window that overlays the content of the conference session.

14. The method of claim 11, wherein enabling the communication to be accessed by the subset of users via the second chat conversation comprises causing the second chat conversation to be displayed in a chat display region of a user interface, wherein the chat display region is configured to switch between displaying the first chat conversation and displaying the second chat conversation based at least in part on selection of a tab.

15. The method of claim 11, wherein enabling the communication to be accessed by the subset of users via the second chat conversation comprises causing the second chat conversation to be displayed in a chat display region of a user interface, wherein the chat display region is configured to concurrently display the first chat conversation and the second chat conversation.

16. The method of claim 11, wherein enabling the communication to be accessed by the subset of users via the second chat conversation comprises adding a representation of the communication to an interactive timeline of the conference session, the communication being accessible by individual ones of the subset of users via the representation added to the interactive timeline.

17. The method of claim 11, wherein enabling the communication to be accessed by the subset of users via the second chat conversation comprises adding a marker associated with the communication to a transcript of the conference session, the communication being accessible by individual ones of the subset of users via the marker added to the transcript.

18. A system comprising:
one or more processing units; and
a computer-readable medium having encoded thereon computer-executable instructions to cause the one or more processing units to:
cause content of a conference session to be displayed via a client computing device;
cause a chat conversation included within the conference session to be displayed via the client computing device;
receive, from the client computing device, a communication submitted to the chat conversation;
receive, from the client computing device, an accessibility life span associated with the communication;
enable access to the communication for one or more users participating in the conference session;
determine that the accessibility life span associated with the communication has expired; and
based on determining that the accessibility life span associated with the communication has expired, prohibit further access to the communication for the one or more users.

19. The system of claim 18, wherein the accessibility life span comprises one of:
a defined duration for accessing the communication;
a defined number of times the communication can be accessed by individual ones of the one or more users; or
a defined total number of times the communication can be accessed by the one or more users.

20. The system of claim 18, wherein the chat conversation comprises a side chat conversation in which the one or more users are enabled to exchange private communications.
